(19) United States
(12) Patent Application Publication
(10) Pub. No.: US 2005/0098622 A1
(43) Pub. Date: May 12, 2005

(54) Dispensing of currency

(76) Inventor: Gregory Jantsch, Gulfport, MS (US)

Correspondence Address: FISH & RICHARDSON PC, 225 FRANKLIN ST, BOSTON, MA, 02110, US

(21) Appl. No.: 10/944,999

(22) Filed: Sep. 20, 2004

Related U.S. Application Data
(63) Continuation-in-part of application No. 10/269,851, filed on Oct. 9, 2002.
Application No. 10/269,851 is a continuation-in-part of application No. 09/973,186, filed on Oct. 9, 2001.

(51) Int. Cl. G06F 17/60; G06F 7/08

(52) U.S. Cl. 235/379; 235/381

(57) ABSTRACT

An apparatus includes a cassette having a chamber to hold a stack of bills, a feeding mechanism to withdraw bills from the stack and feed them to an exit of the cassette, and elements to mount and unmount the cassette on a currency dispenser, the feeding mechanism including an anti-backup roller comprising a polymeric aromatic amide.

This is a continuation-in-part of U.S. patent application Ser. No. 10/269,851, filed Oct. 9, 2002, which is a continuation-in-part of U.S. patent application Ser. No. 09/973,186, filed Oct. 9, 2001, both of which are incorporated here in their entirety, and this application claims the benefit of priority of both of those applications.

### BACKGROUND

This invention relates to dispensing of currency.

Currency dispensers are found, for example, in automatic teller machines (ATMs), including those for so-called off-premises use (for example, at an airport, grocery store, or other location not controlled by a financial institution).

A typical currency dispenser includes a removable money box called a cassette. A stack of currency is loaded into the cassette and then delivered to and loaded into the dispenser.

The dispenser receives signals from control circuitry in the ATM when a user asks for cash. The signals could, for example, instruct the dispenser to dispense $300 in $20 bills to the user.

The dispenser includes paper transporting mechanisms that remove the needed number of bills from the money box, one after another. Each removed bill is fed along a paper path to a position at which the bill is ejected to the outside world, where the user can reach it. The dispenser then signals the control circuitry in the ATM that the needed number of bills has been dispensed.

The sheets of currency that are stacked in the money box sometimes stick together and cannot be easily separated for dispensing. So-called double detection devices are provided in dispensers to detect when more than one paper bill has been removed from the stack. The multiple bills are then discarded into a second money cassette for later pickup, rather than being dispensed to the user.

A typical currency dispenser is constructed of metal pieces, shafts, and bearings that are assembled by a lengthy sequence of steps.

### SUMMARY

In general, in one aspect, an apparatus includes a cassette having a chamber to hold a stack of bills, a feeding mechanism to withdraw bills from the stack and feed them to an exit of the cassette, and elements to mount and unmount the cassette on a currency dispenser, the feeding mechanism including an anti-backup roller comprising a polymeric aromatic amide.

Implementations may include one or more of the following features. The polymeric aromatic amide comprises Kevlar or Twaron. The feeding mechanism includes a drive roller and the drive roller and the anti-backup roller are configured to apply respectively different amounts of friction to bills being withdrawn from the cassette. The anti-backup roller and the drive roller are configured so that the anti-backup roller touches the bills over a larger surface area than the drive roller. There are more than one drive roller and more than one anti-backup roller.

In general, in another aspect, an apparatus includes a cassette having a chamber to hold a stack of bills; a feeding mechanism to withdraw bills from the stack and feed them to an exit of the cassette; and elements to mount and unmount the cassette on a currency dispenser. The feeding mechanism includes an anti-backup roller comprising a polymeric aromatic. A substantially linear paper path is arranged between the exit of the cassette and a dispensing location at which the currency can be dispensed to a customer, the paper path comprising rotational shafts arranged to transfer the currency. A housing is configured to support the paper path and to receive the cassette, the housing including two parallel spaced-apart molded side walls, a third molded side wall between the two parallel molded side walls, a molded top wall configured to support electromechanical drive elements, and a molded bottom wall, the five walls being separate pieces. A double-detect mechanism is mounted on the paper path at the exit of the cassette, the double-detect mechanism comprising a rotating element that is electromagnetically coupled to a detector on a stationary element.

Other advantages and features will become apparent from the following description and from the claims.

### DESCRIPTION

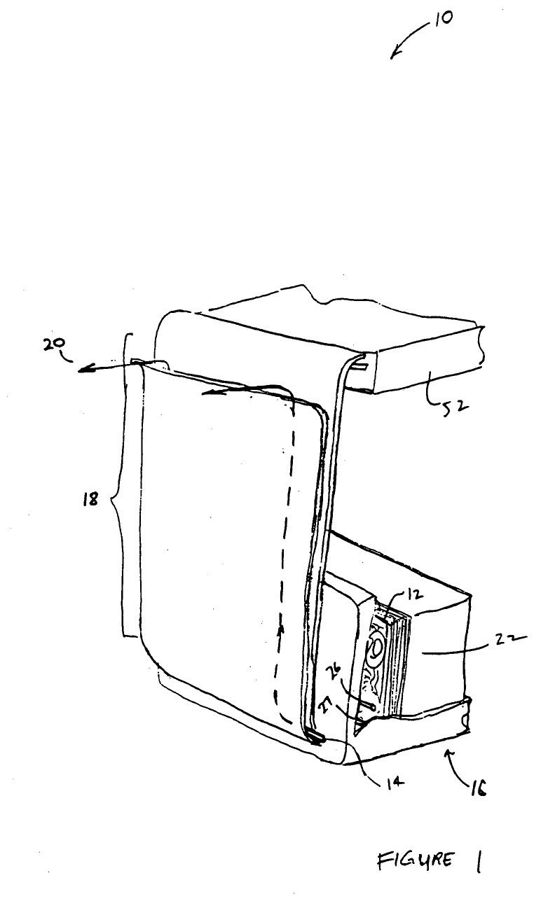

FIG. 1 is schematic perspective view of a currency path through a currency dispenser.

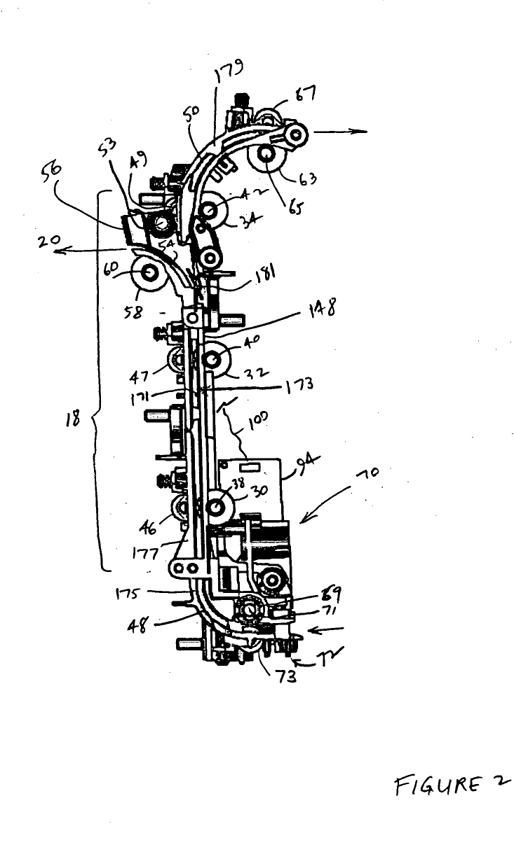

FIG. 2 is a side view of a portion of a currency dispenser that defines a paper path.

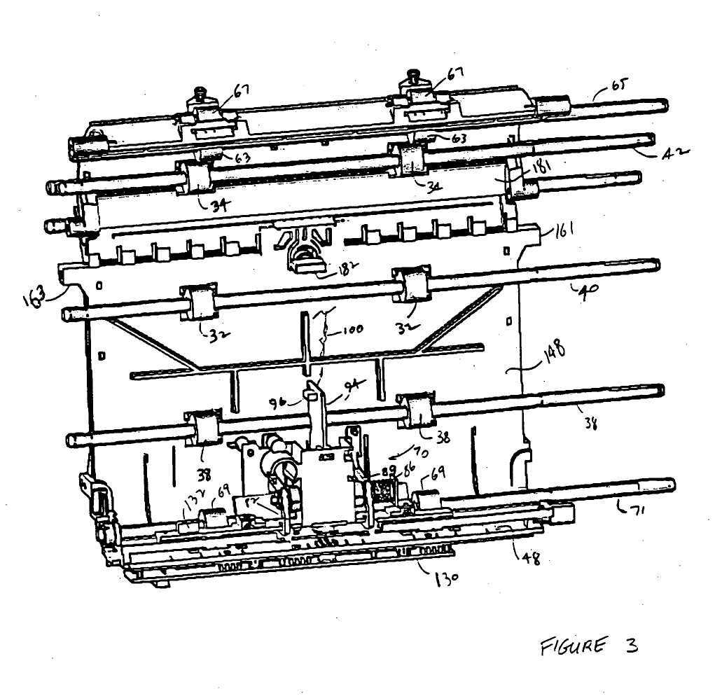

FIG. 3 is an isometric view looking at the side of the paper path mechanism that faces the inside of the dispenser.

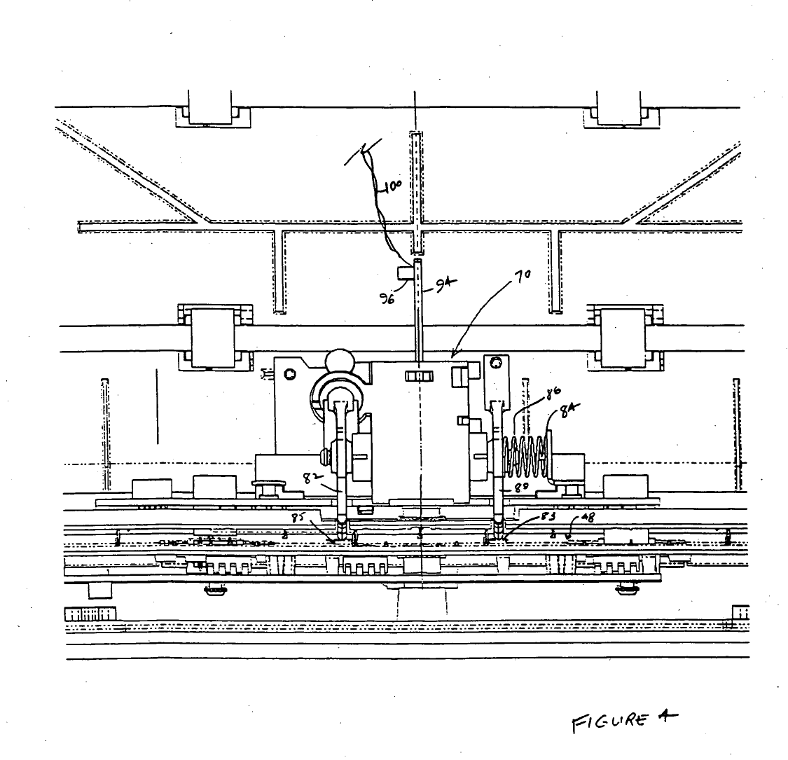

FIG. 4 is a front view of a double-detect mechanism.

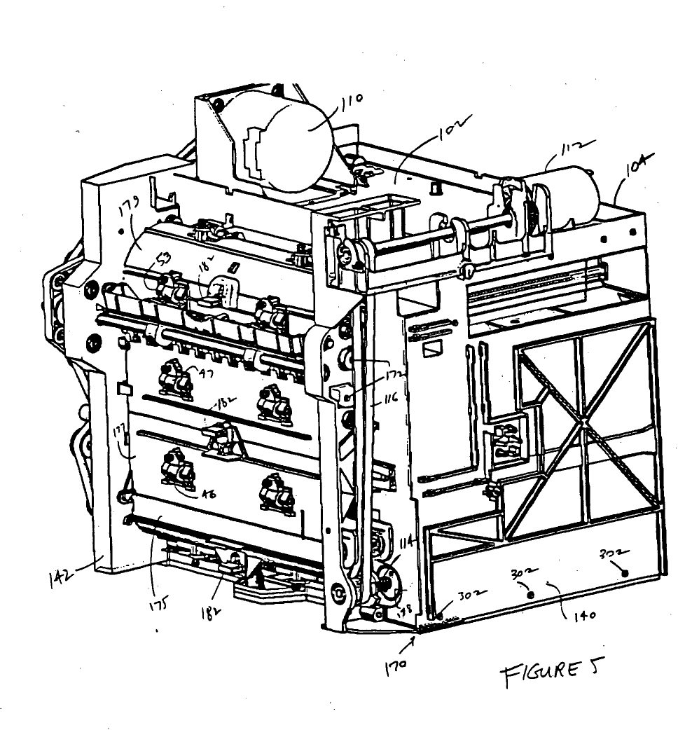

FIG. 5 is an isometric view looking toward the back and one side of the dispenser.

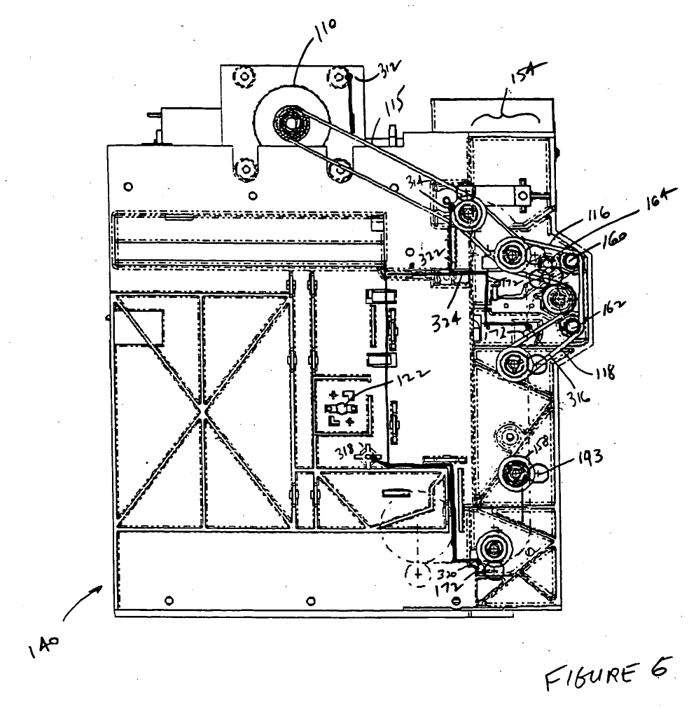

FIG. 6 is a view of one side of the dispenser.

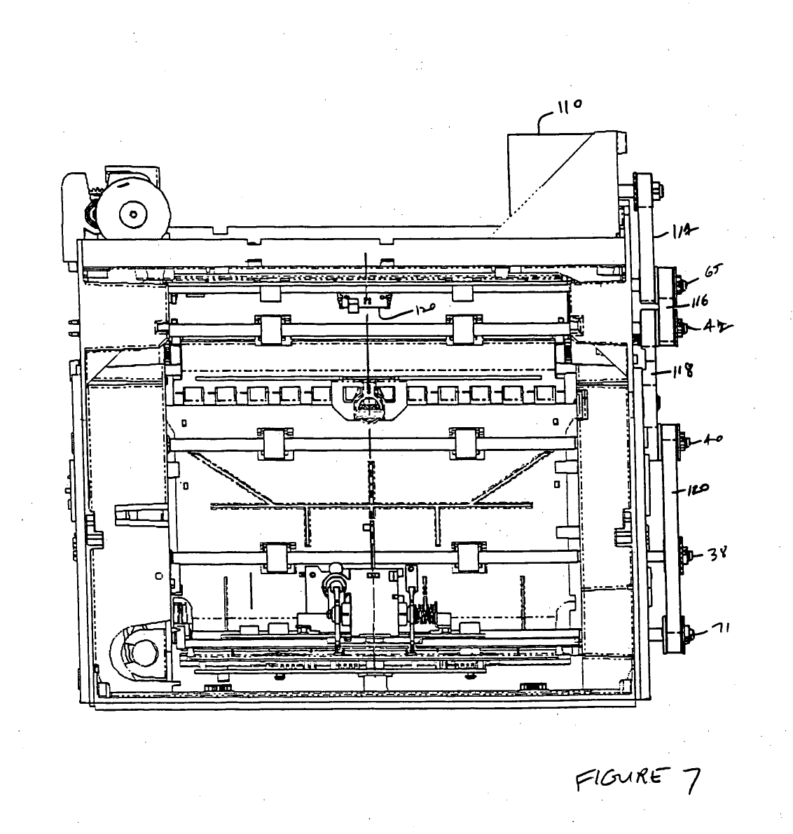

FIG. 7 is a front view of the dispenser looking toward the inside of the back wall.

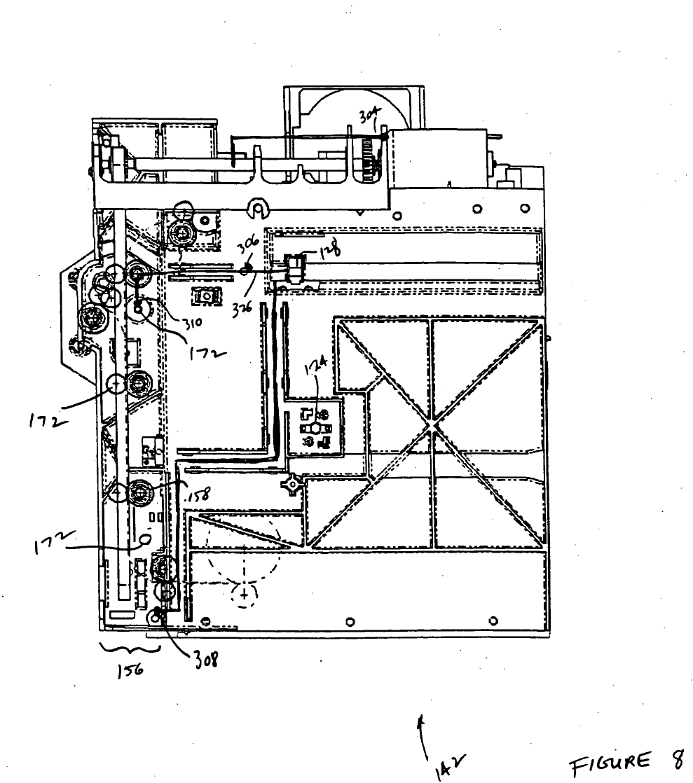

FIG. 8 is a view of the other side of the dispenser.

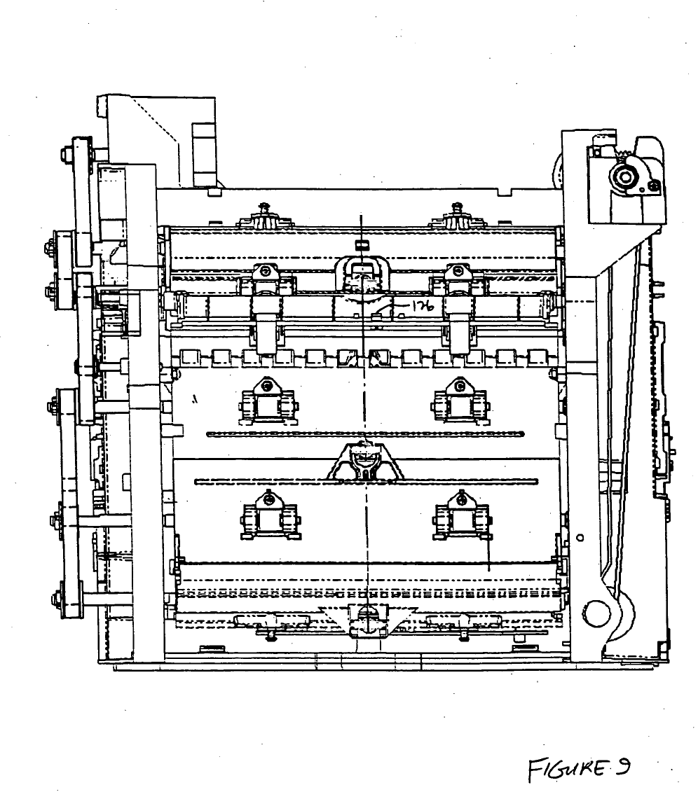

FIG. 9 is a view of the back side of the dispenser.

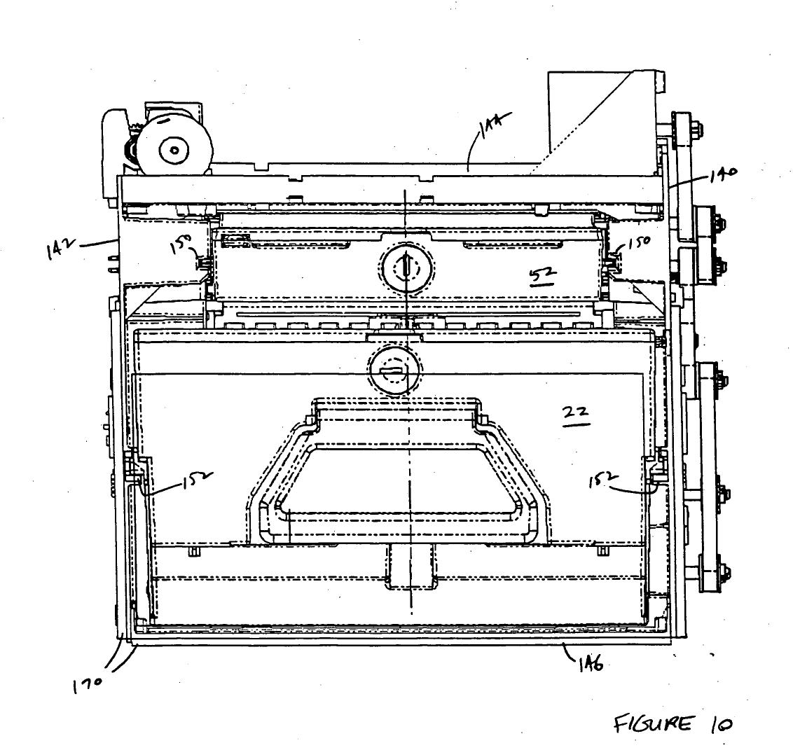

FIG. 10 is a view of the front of the dispenser.

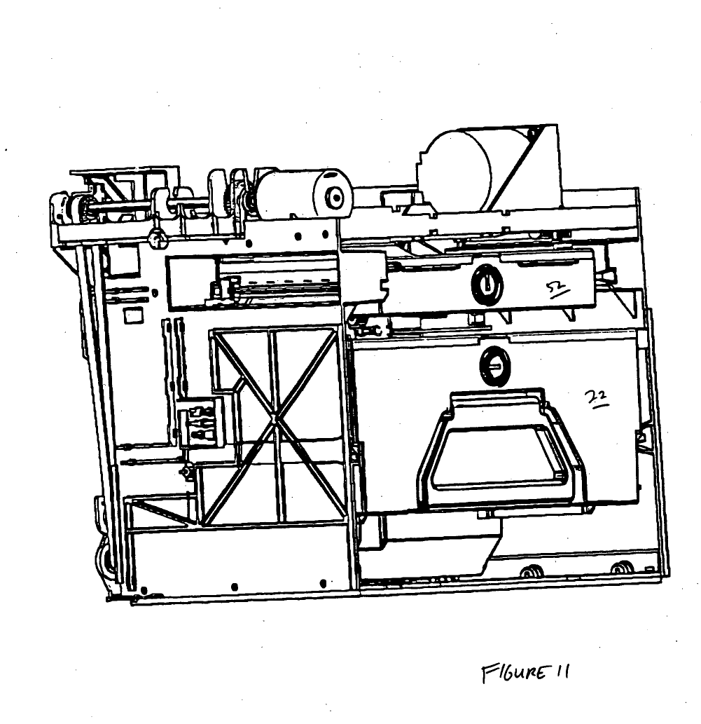

FIG. 11 is an isometric view of the front and one side of the dispenser.

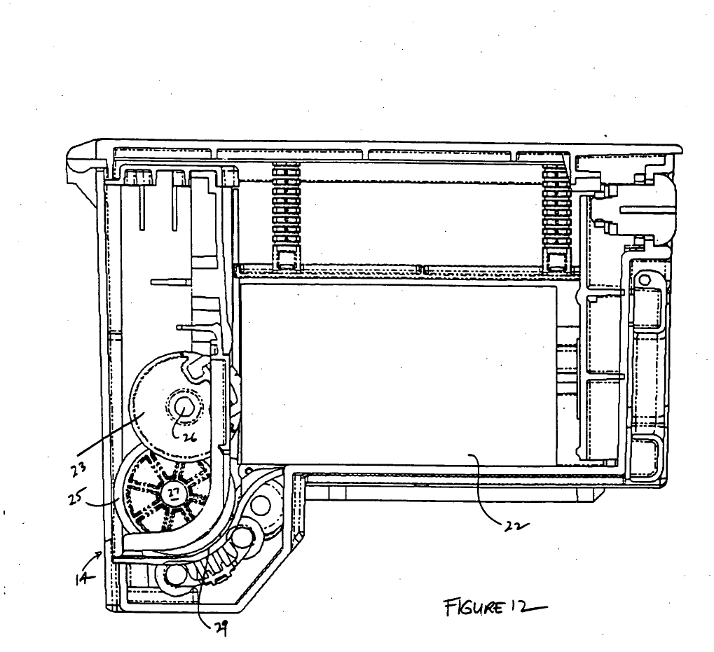

FIG. 12 is a side view of a money cassette.

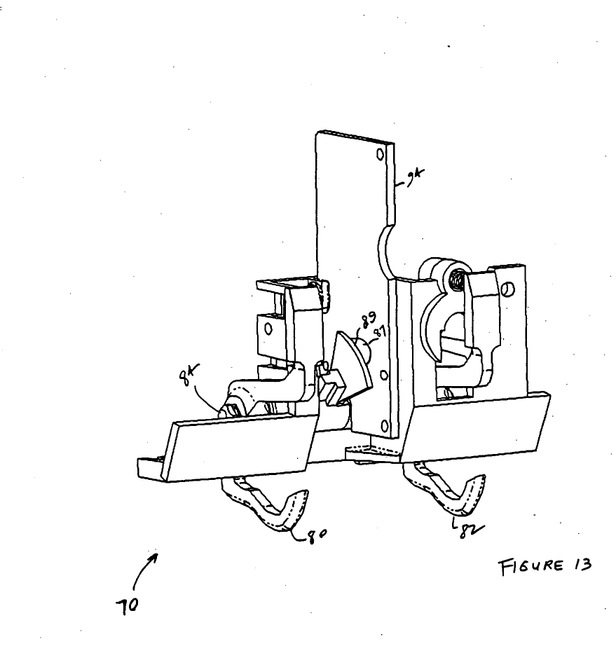

FIG. 13 is a three-dimensional view of a bill thickness detector.

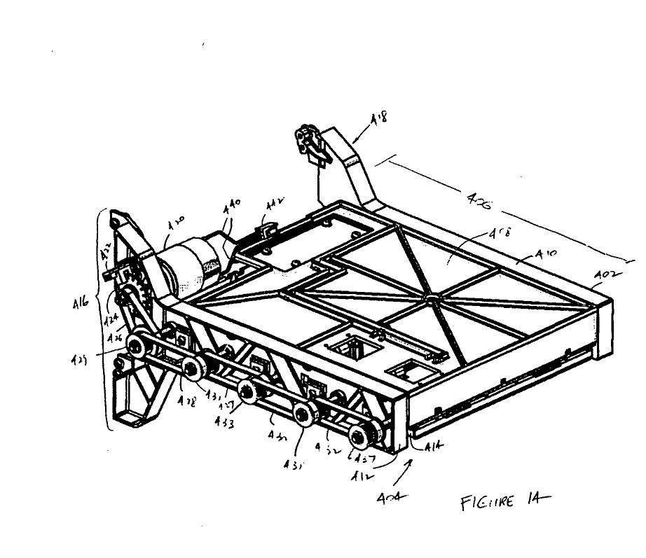

FIG. 14 is an isometric view of an extension device.

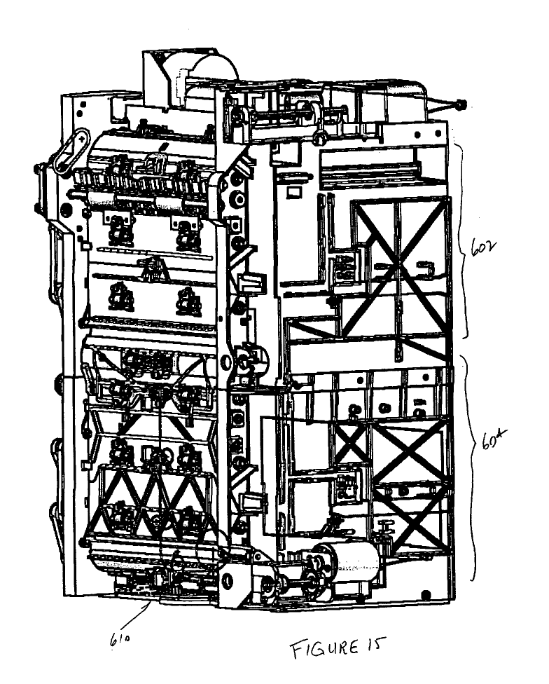

FIG. 15 is an isometric view of one side of an alternate dispenser.

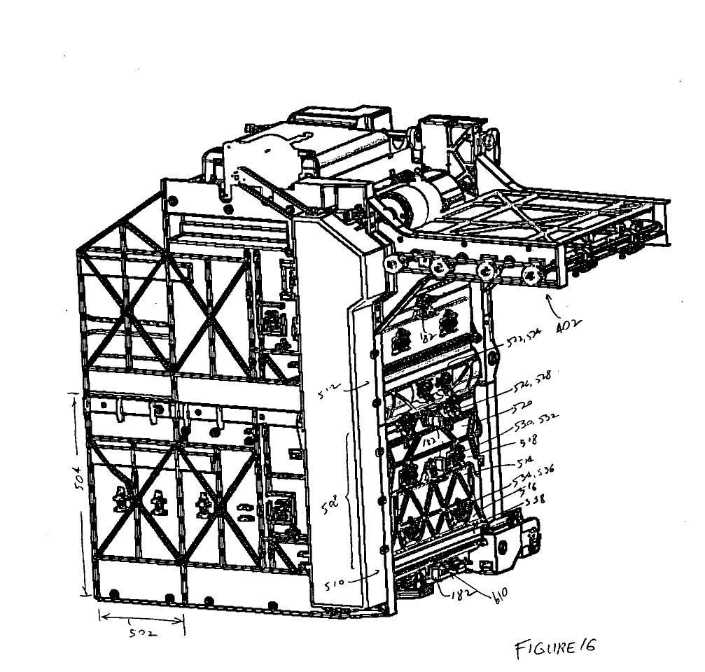

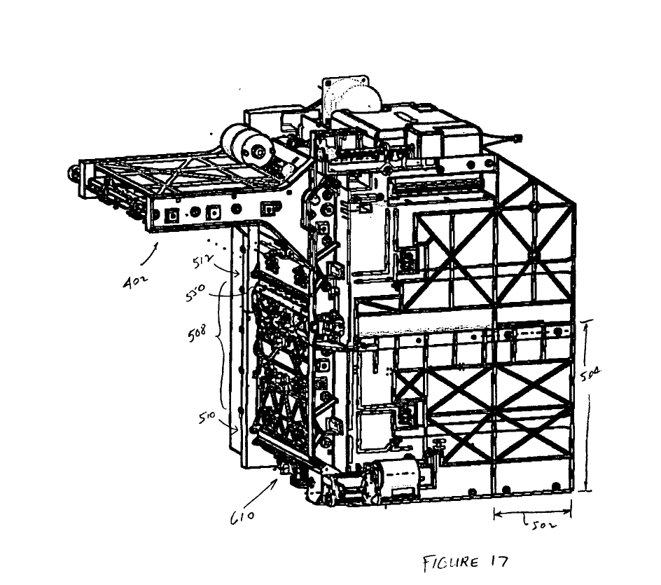

FIGS. 16 and 17 are isometric views of opposite sides of another alternate dispenser and extension device.

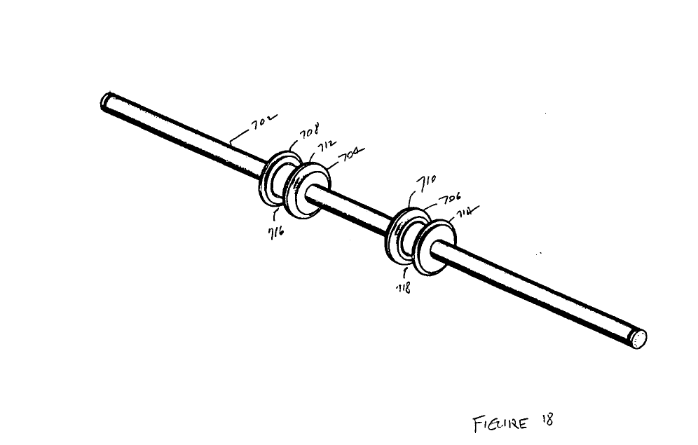

FIG. 18 is an isometric view of rollers on a shaft.

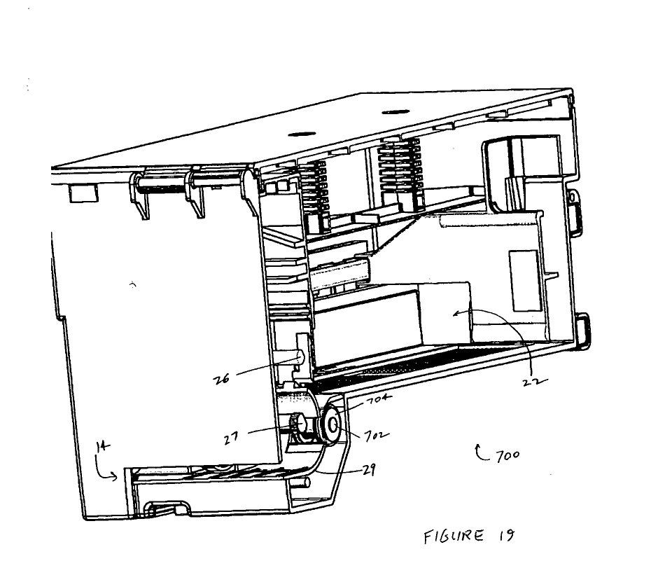

FIG. 19 is an isometric view of a currency cassette.

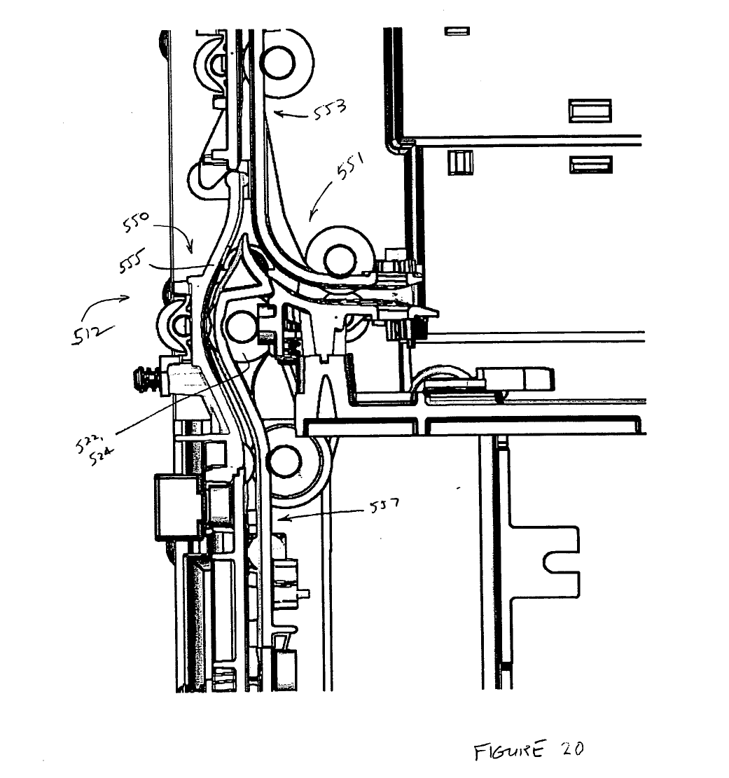

FIG. 20 is a sectional side view of paper paths.

As shown in FIG. 1, in a currency dispenser 10, individual paper bills 12 are withdrawn one at a time from an opening 14 of a money box 16 (where a supply of bills is stored) and delivered along a linear paper path 18 to a dispensing location 20 for access by a customer.

As shown in FIG. 12, the bills are stored in a stack 22 inside of the money box and are peeled one at a time from the stack by the rotation of frictional rollers 23, 25 mounted on two parallel shafts 26, 27. As each bill is peeled from the stack it is driven over a curved surface 29 inside the money box so that, when it leaves the money box at opening 14, the bill is oriented perpendicularly to its orientation in the stack.

As shown in FIGS. 2 and 3, the withdrawn bill is then driven along the paper path 18 by three pairs of frictional rollers 30, 32, 34 that are mounted on three parallel shafts 38, 40, 42 arranged along the length of the paper path. Each of the rollers cooperates with an idling nip roller 46, 47, 49 to grip the bill and drive it along the paper path.

At the lower end of the paper path a curved surface 48 diverts the bill to a direction of motion that is perpendicular to the direction in which the bill leaves the money box.

At the upper end of the paper path, the traveling bill can either be diverted by a curved surface 50 into a rejected bill collection box 52 (FIG. 1) or by a curved surface 54 (FIG. 2) to the dispensing location 20. Which way the bill travels depends on the position of a control vane 56 that can be rotated (about an axle 53) between two positions. The vane is spring-biased to a default position that rejects bills into the collection box and must be driven to the dispensing position. (The default routing is applied only to the first bill in the series after which the remaining bills in the series are routed by default to the dispensing location, unless one of those remaining bills is also determined to be flawed.)

A bill that is diverted to the dispensing location is driven out of the paper path by a fourth pair of frictional rollers 58 (mounted on a shaft 60) and nip rollers. A bill that is diverted to the collection box is driven by rollers 34 and by a fifth pair of frictional rollers 63 (mounted on a shaft 65) and nip rollers 67. A sixth pair of frictional rollers 69 (mounted a on shaft 71) and nip rollers 73 drives the bill past the curved surface 48 as it is withdrawn from the money box.

As shown also in FIGS. 4 and 13, the bottom end of the paper path supports a double-detect mechanism 70 that is used to determine, for example, when more than one bill has been withdrawn from the money box at one time. If so, the dispenser leaves the vane 56 (FIG. 2) in the rejection position and the multiple bills are rejected into the collection box. Otherwise, the vane is forced to the dispensing position and the single bill is dispensed to the customer.

The double-detect mechanism determines whether more than one bill has been withdrawn from the money box by measuring the thickness of the bill and comparing it to a maximum thickness value. The thickness is measured by two fingers 80, 82 (FIG. 4) that are mounted on opposite ends of a rotating shaft 84 and are spring biased against surface ridges 83, 85 by a spring 86 on shaft 84.

As the bill is grabbed at the nip points between the fingers and the ridges (the nip points are spaced above the curved surface 48) and pulled along the surface 48, the bill forces the fingers upward by a distance equal to the thickness of the bill. As the fingers are pushed upward, they cause a corresponding rotation of the shaft 84. The rotation causes a pair of metal paddles 89 (FIG. 13; only one paddle is shown, the other being the same shape as, parallel to, and mounted in the same orientation on the other side of board 94, as paddle 89). The paddles are mounted perpendicularly on the shaft to rotate with respect to stationary metal elements 87 (only one shown) that are formed on the surfaces of a circuit board 94 (FIG. 4), which is fixed in an orientation perpendicular to the shaft. The stationary elements on the board form primary and secondary inductance coils, and the paddles provide a field path linking the coils. The metal paddles are electromagnetically coupled to the stationary elements so that the amount of rotation of the shaft 84 can be precisely detected by circuitry 96 mounted on the circuit board. A circuit board of this kind, known generally as a rotary variable inductance transducer (RVIT) is available from TRW Electronics of Hampton, Va.

The circuitry includes an analog-to-digital (A/D) converter, which receives an analog voltage signal generated by the rotation of the paddles relative to the stationary elements.

The algorithm for determining the thickness proceeds as follows: Before the note is pulled from the cassette, the voltage from the RVIT is read (through the A/D converter) to establish a baseline value for the RVIT. As the note is withdrawn from the cassette, the skew and length are determined, and the note is rejected if these values are outside required limits. Skew is a deviation from a condition in which the leading and trailing edges of the note are perpendicular to the path of travel. Length is the dimension of the note measured along the axis parallel to the normal direction of travel. For the typical note this is the shorter of the two dimensions.

As the note is withdrawn, software samples the A/D thickness readings and looks for a significant change from the baseline value. A significant change indicates that the leading edge of the note is under the fingers. Then, the software begins to sample the thickness at regular intervals (approximately every 2 milliseconds). The readings are sorted into even and odd samples (e.g., the first and third readings are even, and the second and fourth readings are odd). The even samples are added together as they are received. The same is true for the odd samples. The software watches for the thickness values to return to the approximate level of the established baseline, indicating that the trailing edge of the note has been detected. Then the even and odd sampling ceases.

The note thickness algorithm is loosely based on ‘Simpson's Rule’ for approximating the area enclosed by an irregular shape. Briefly (with some simplification), ‘Simpson's Rule’ breaks a shape into narrow strips. The area of the overall shape can be approximated by summing the areas of the strips. The irregular outline of the shape is approximated by fitting a parabola through the endpoints of each pair of adjacent strips.

Simpson's Rule is used to calculate the area of a cross section of the note, namely, of the rectangle presented when the note is viewed on edge along the short side. Since the typical note is not exactly flat as measured by the double detect fingers (there are always bumps, creases, debris, and other factors that affect the actual shape of the cross section), the rectangle of the cross section is always irregular in shape. The data required to utilize Simpson's Rule is a series of measurements of the note thickness at regular intervals. These measurements are taken as the note travels through the note path from the cassette toward the exit. If the note fails to meet the thickness requirements, the vane forces the note into a reject bin, and a new note is pulled from the cassette to replace the rejected note.

The software then applies Simpson's Rule using the formula:
Area=(4*Sum of odd samples)+(2*Sum of even samples)

The Area is divided by the number of samples taken to compensate for the speed of the note as it traveled past the thickness sensor and for notes of varying length. This gives a numeric value proportional to the average thickness of the note.

The output signal of the circuitry representative of the thickness is carried by a conductor 100 (FIG. 4) to dispenser control circuitry 102 mounted a top wall 104 as shown in FIG. 5. The value for the average note thickness is compared to a pre-determined range of valid readings. If the note thickness is either too high or too low, the note is rejected. If the dispenser control circuitry determines from the double-detect signal that the note thickness is within a permitted range (e.g., because only one bill has been withdrawn), it triggers a solenoid not shown to move the vane to the dispensing position.

An algorithm is also provided for determining the skew and length of bills. The algorithm uses information generated from a sensor 72 (FIG. 2) that is located ahead of the double detector. Sensor 72 includes three light sources across the width on one side of the paper path (one in the middle and one on each end) and three corresponding detectors on the opposite side of the paper path.

The skew is determined using a hardware timer, three software timers (counters), and sensor 72. The hardware timer is set up to generate an interrupt every 1 millisecond. During an interrupt service routine, a global variable is incremented. This global variable (or count) is used by the main software to time events and to trigger actions.

Before the note is “picked”, the three software counters are set to 0 and the software is set up to begin incrementing these counters every 1 millisecond (based on the global count maintained by the hardware timer). As the note is picked and is removed from the cassette, the sensors are being monitored by the software. One sensor is associated with each of the three software counters, When the leading edge of the note reaches (or blocks) a sensor, the corresponding counter is read and the counter value (number of milliseconds) is stored in a memory location. When all three sensors have been tripped and the software counters are stored for each, then the leading edge skew may be determined. (The counters continue to increment in order to determine the trailing edge skew later.)

To determine the leading edge skew, the software uses the readings from the outer two sensors. The difference between these two values is an indication of the amount of skew present. If this skew is excessive, the note will be rejected.

Meanwhile, assuming the leading edge skew is within allowed limits, the counters are still active to determine the trailing edge skew. As each of the three sensors becomes no longer blocked, the corresponding counter is stopped and read again. When all the sensors are no longer blocked, the difference in the two readings indicates the trailing edge skew.

The length of the note is determined using the same software counters used by the skew calculations. For this calculation, the value for each counter that was read at the leading edge is subtracted from the value read at the trailing edge. This gives three values for the “length” of the note at three locations along the note. The three “length” values are then averaged to determine the average “length” of the note (in milliseconds). The resulting calculated length is compared to a standard value and the note is rejected if out of limits.

The skew sensors are also used for jam detection. Of one or more of the three sensors indicates an excessive time for the bill to clear the sensors, a jam is assumed to be likely and a jam recovery routine is initiated to restore operation to normal, including completing the transaction during which the jam occurred.

Among the advantages of providing a skew and length sensor immediately ahead of, but separately from the double detect mechanism are simplicity of construction and operation, accuracy of both the double detection and the skew detection, and jam detection and recovery which permits unattended operation.

Also mounted on the top wall are two motors 110, 112 (FIG. 5). As shown in FIGS. 5, 6, and 7, motor 110 drives a series of timing/drive belts 115, 116, 118, 120, which in turn drive shafts 65, 42, 40, 38, 71 through gears. Motor 112 (FIG. 5) separately drives a shaft 114 (FIG. 5) through a belt 116. Shaft 114 provides torque to drive the bill peeling mechanism inside of the money box.

Photoelectronic sensors 120 (FIG. 7), 122 (FIG. 6), 124 (FIG. 8), 126 (FIG. 9), 128 (FIG. 8), 130, and 132 (FIG. 3) are mounted on the housing of the dispenser in locations that enable detection of the presence of a money box and a collection box in the housing and of the presence of a bill at points along the route traveled by the bill from the money box to the collection or the dispensing location.

The control circuitry uses information from the sensors and from external circuitry located in the ATM to control accurately the motors and the vane to dispense bills in accordance with the customer's request and to reject bills that fail the double-detect testing.

The housing of the dispenser is assembled using four walls 140, 142, 144, 146 (FIG. 10) all of which are molded of polycarbonate with 10% carbon fiber for conductivity, a lightweight yet strong plastic material.

As shown in FIG. 10, the two parallel sidewalls 140, 142 each bear integral slots 150, 152 to support and permit easy insertion and removal of each of the collection box and the money box. Each of the sidewalls also includes a bearing support flange 154 (FIG. 6), 156 (FIG. 8) that includes holes in which plastic shaft bearings 158 (FIG. 8) are mounted. The shaft bearings hold and permit rotation of the corresponding shafts. The bearing support flange also supports non-rotating short shafts 160, 162, 193 (FIG. 6) that hold idler gears, and a rotating shaft 164 that supports and permits rotation of the vane.

Each of the shafts 65, 42, 58, 40, 38, 69 is held by and terminates at one end at one of the snap-in bearings. At the other end, each of the shafts projects beyond the snap-in bearing to support one of the gears.

The bearing support flange of side wall 142 also holds the shaft that is used to drive the internal mechanism of the money box.

Both side walls bear stiffening ridges and other stiffening features as shown.

The top and bottom walls 144, 146 also bear stiffening features and are connected to the side walls by metal screws 302 (FIG. 5). Only three screws are needed along the mating edges of each pair of walls, e.g., the mating edges 170.

Rear wall 148, which defines the flat linear portion of the paper path and the curved feeding surfaces at each end of the linear portion, is mounted between the two side walls using three screws 172 (FIG. 8)on each side. Fingers 161, 163 (FIG. 3) hold the paper path in a fixed position.

The paper path is defined by a channel 171 (FIG. 2) between one fixed surface 173 and facing surfaces of a series of four hinged doors 175 (FIG. 5), 177, 179, and 181 (FIG. 2). The doors and panel bear the nip rollers. The doors can be unclasped using keys 182 (FIG. 5) and opened to permit clearing of ajammed bill from the paper path.

When the money box is inserted into the housing, a key (not shown) enters a slot (not shown) in the front wall of the money box. The key triggers a mechanism (not shown) that opens a window (not shown), permitting a drive wheel 178 (FIG. 5) to enter the money box. The drive wheel 178 engages with and drives the bill peeling mechanism inside the money box.

A pattern of electrical discharge points 304, 306, 308, 310, 312, 314, 316, 318, 320, 322 (FIGS. 6 and 8) is arranged on the surfaces of the left and right sidewalls. The electrical discharge points are in the form of metal lugs attached to the sidewalls and are interconnected electrically by braided metal wire sections 324, 326. Connection points 308, 310, 314, 316, and 320 are attached near the ends of metal shafts to the frame panels that serve portions of the paper path as explained earlier. Connections 312 and 314 are connected to machine electrical ground. The pattern of grounding elements establishes short distances between discharge points to compensate for the internal resistance of the plastic carbon filled material that form that walls, thus effectively keeping static electricity from building up to a charge large enough to arc. The grounding elements also reduce static electricity that may cause bills to cling to the parts of the dispenser or to each other.

Because the dispenser is assembled from a small number of lightweight, easy to manipulate parts, assembly is fast and inexpensive, and the resulting dispenser is small, lightweight, and inexpensive. Maintenance can be done easily and inexpensively in case any part breaks or malfunctions.

Construction of the dispenser proceeds in the following sequence. The dispenser is designed for z-axis assembly. First, bearings and small components are installed on the left and right sidewalls. Then the bottom and top walls are installed on the left sidewall using screws. Then shafts and paper paths are installed on left sidewall. The right sidewall is then installed over all the locations established by the earlier parts. Subassemblies such as cassette motor drive, money box motor drive, paper path drive, and the control boards are then installed on the top wall, and the sensors are installed. Electrical harnesses are installed after every other part is assembled. The z-axis assembly technique allows fast and accurate placement of components.

Other implementations are within the scope of the following claims.

For example, as shown in FIGS. 14, a removable extension device 402 can be provided to be attached to a currency dispenser at the place where the currency is dispensed. The extension passes the currency to a new dispensing location 404 located a distance 406 from the original dispensing location, This enables the bills to be dispensed through a wall of a building or other housing that holds the dispenser. The extension device is mounted on the dispenser at the brackets 416, 418 using screws. The extension includes top, bottom, and side walls 408, 414, 410, and 412 that are built using materials, ribbing, and construction similar to the construction of the dispenser as described above. The bottom wall also serves as the paper path.

A motor 420 mounted on the extension receives power from a connector 442 that is attached to an electrical power source on the dispenser, using two wires 440. The shaft of the motor 420 bears an encoding wheel 424 that has radial slots arranged around its periphery. As the wheel rotates, the slots are read by a sensor 422 and the sensor signals are returned to the electronic control circuitry on the dispenser, which can use it to control the speed of the motor. This assures that the bills delivered by the dispenser to the extension are picked up and moved at a speed that is comparable to the speed at which they are delivered, to prevent folding or ripping of the currency.

The motor 420 drives five driving axles 429, 431, 433, 435, 437 using belts 428, 427, 430, 432, that operate on corresponding pulleys. Each axle bears two feeder wheels that drive the currency along a flat path from the point at which the currency is picked up from the dispenser to the dispensing point 404.

In some implementations of the currency dispenser shown in FIG. 5, its capacity and capabilities are enhanced by including more than one currency cassette and/or by extending the length of the one or more than one currency cassette to hold more currency.

For example, as shown in FIGS. 16 and 17, the depth of the currency cassettes may be increased, relative to FIG. 5, by the amount identified as 502, and a second cassette 504 may be added at the bottom of the dispenser. FIGS. 16 and 17 also illustrate how the extension device 402 may be attached to the dispenser to receive bills delivered at the dispensing location 20 (FIG. 5)

A linear paper path 508 is defined between the discharge end 510 of the lower cassette 504 and the discharge end 512 of the upper cassette. As in the case of the upper cassette described earlier, the paper path of the lower cassette includes hinged doors 514, 516, 518, 520 that can be released by keys 182. Bills are driven along the linear paper path by the frictional surfaces of drive wheels 522, 524, 526, 528, 530, 532, 534, and 536, that are held on shafts mounted like the ones that serve the upper cassette.

As shown in FIG. 20, at the location 512 where the upper cassette discharges its bills, a curved bypass path 550 enables bills fed from the lower cassette to bypass the delivery mechanism 551 of the upper cassette and to be passed to the linear path 553 of the upper cassette which then carries the bills to the dispensing location.

The curved bypass path includes an outer curved plate 555 that interfaces with the existing paper path by forcing the bill to stay on the outer surface of the paper path. The bill thus passes over a paper path transport slot of the upper cassette. In this way the two paper paths from the two cassettes merge into one paper path 553. The wheels 522, 524 drive the bills through the curved path.

FIG. 15 shows another example in which the upper and lower cassettes 602 and 604 are shorter and have a smaller capacity for bills. The capacity of the longer cassettes of FIGS. 16 and 17 could be 1300 bills, for example, and of the shorter cassette 550 bills.

In the examples in which a lower cassette is provided, a second double-detect mechanism 610 is provided at the discharge location of the lower cassette and operates in the same way as the double-detect mechanism of the upper cassette.

The same static electricity grounding arrangements described earlier are extended to include the larger cassettes and the additional cassettes and the parts are, as in the earlier discussion, molded of polycarbonate with 10% carbon fiber for conductivity.

As seen in FIGS. 18 and 19, in some examples, the cassette 700 has a shaft 702 and a pair of rollers 704, 706 that are fixed on the shaft.

Each of the rollers is made of urethane with fibers embedded. The fibers are polymeric aromatic amide, for example, sold under the brand names Kevlar or Twaron. In some examples, the rollers comprise 4% by weight of fiber. Smaller percentages may work well, for example, 2% to 4% by weight. For percentages of fiber greater than 4% by weight, the rollers may not work as well due to the coefficient of friction being too low. The fibers make the rollers more wear resistant. A larger percentage of fibers increases the wear resistance but also reduces the coefficient of friction. The design of a particular roller should take account of this tradeoff.

Rollers of this kind are available from Rotodyne Engineered Products of Spencerport, N.Y. The rollers are made by forming a roller shape from a matrix of urethane with the fibers embedded. The rollers are then ground to the desired size and shape. Additional special grinding may then be required to remove long fibers that may be left after the initial grinding.

The rollers 704, 706 serve as anti-backup rollers with respect to the delivery of bills from the cassette. The anti-backup rollers are not driven but are mounted to be stationary relative to the cassette housing. Each anti-backup roller has two rims 708, 712, 710, and 714 separated by recesses 716, 718. The recesses accommodate and define an interface with the drive wheels 25. The drive wheels (rollers) are driven clockwise to pull and then drive the bills into the interface defined by the anti-backup rollers and the corresponding drive rollers. The outer surfaces of the rims of the rollers bear on the bills as they are driven by wheels 25 to pass over curved surface 29 and out of the cassette. As the drive rollers pull bills into the interface, the bills are forced to corrugate because the drive wheels nestle within the recesses 716, 718. Because there are two rims of each of the anti-backup rollers, the corrugation causes the rims to touch the bills over a larger surface area than do the drive wheels. This larger surface area, combined with the fact that the anti-backup rollers are made of a rubber (e.g., urethane) material, causes the rims to apply more frictional force to one side of the bill surface than the driving force applied by the drive wheels to the other side.

As a result, if the drive rollers simultaneously pick up two bills from the stack in the cassette, as the two bills are driven into the interface between the drive wheels and the anti-backup rollers, the anti-backup rollers impede the movement of the second bill (the one that is not at the end of the stack when the feeding begins) while allowing the first bill (which is in contact with and is therefore driven by the drive rollers) to pass through. The first bill does not touch the anti-backup roller; only the second bill does. The first bill is then pulled through the system. The second bill becomes the next bill to be fed and the process begins again. Because the anti-backup rollers work by virtue of applying friction to the bill surfaces, they are prone to rapid wear, which is ameliorated to some degree by the construction of the rollers described earlier/

The two cassettes typically would contain bills of different denominations, for example, tens and twenties. The amount of money to be dispensed can be used to select the denominations of bills, which in turn determines the cassette or cassettes from which the bills need to be drawn. The dispenser is able to withdraw bills from either cassette or both of them as needed and in any order.

In other applications, the default rule used by the control software may be to feed bills only from one cassette until it is empty, and then from the other cassette. For example, if $50 is to be dispensed, the lower cassette could first be controlled to deliver two $20 bills after which the top cassette could be controlled to feed one $10 bill to complete the transaction. The cassette denominations are typically determined by the software of the device (e.g., an ATM) of which the currency dispenser forms a part. The software in the ATM or the software of the currency dispenser may then determine with which bills to fill an amount requested by a customer.

1. Apparatus comprising
a cassette having
a chamber to hold a stack of bills,
a feeding mechanism to withdraw bills from the stack and feed them to an exit of the cassette, and
elements to mount and umnount the cassette on a currency dispenser,
the feeding mechanism including an anti-backup roller comprising a polymeric aromatic amide.

2. The apparatus of claim 1 in which the polymeric aromatic amide comprises Kevlar or Twaron.

3. The apparatus of claim 1 in which the feeding mechanism includes a drive roller and the drive roller and the anti-backup roller are configured to apply respectively different amounts of friction to bills being withdrawn from the cassette.

4. The apparatus of claim 3 in which the anti-backup roller and the drive roller are configured so that the anti-backup roller touches the bills over a larger surface area than the drive roller.

5. The apparatus of claim 1 in which there are more than one drive roller and more than one anti-backup roller.

6. Apparatus comprising
a cassette having
a chamber to hold a stack of bills,
a feeding mechanism to withdraw bills from the stack and feed them to an exit of the cassette, and
elements to mount and unmount the cassette on a currency dispenser,
the feeding mechanism including an anti-backup roller comprising a polymeric aromatic amide,
a substantially linear paper path arranged between the exit of the cassette and a dispensing location at which the currency can be dispensed to a customer, the paper path comprising rotational shafts arranged to transfer the currency,
a housing configured to support the paper path and to receive the cassette, the housing including two parallel spaced-apart molded side walls, a third molded side wall between the two parallel molded side walls, a molded top wall configured to support electromechanical drive elements, and a molded bottom wall, the five walls being separate pieces, and
a double-detect mechanism mounted on the paper path at the exit of the cassette, the double-detect mechanism comprising a rotating element that is electromagnetically coupled to a detector on a stationary element.
